(19) United States
(12) Patent Application Publication
(10) Pub. No.: US 2021/0231112 A1
(43) Pub. Date: Jul. 29, 2021

(54) SWASH-PLATE TYPE PISTON PUMP MOTOR

(71) Applicant: Komatsu Ltd., Tokyo (JP)

(72) Inventors: Shigeyoshi KAWAKITA, Tokyo (JP); Shunsuke KOIDE, Tokyo (JP); Hiroaki MOTOSHIMA, Tokyo (JP)

(21) Appl. No.: 17/050,991

(22) PCT Filed: Mar. 13, 2019
(86) PCT No.: PCT/JP2019/010222

§ 371 Date: Oct. 27, 2020

(30) Foreign Application Priority Data
Jul. 23, 2018 (JP) 2018-137490

(51) Int. Cl. F04B 1/126; F04B 1/2078; F04B 1/2064; F04B 53/14

(52) U.S. Cl. CPC F04B 1/126; F04B 53/14; F04B 1/2064; F04B 1/2078

(57) ABSTRACT

A swash-plate type piston pump motor includes: a rotary shaft; a cylinder block that rotates together with the rotary shaft; a plurality of pistons (5) each of which is inserted so as to be reciprocable in each of a plurality of cylinders formed in the cylinder block; a plurality of piston shoes (6) attached so as to be swingable to an end portion (501) of each piston; a swash plate (7) inclined with respect to an axis of the rotary shaft and having a sliding surface (41) being in contact with a plurality of piston shoes; and a shoe retainer (8) configured to press the piston shoe against the sliding surface. Each piston shoe includes a shoe body (71) being in contact with a sliding surface, and an elastic body (79) provided between the shoe body and the shoe retainer.

### TECHNICAL FIELD

The present invention relates to a swash-plate type piston pump motor.

This application claims priority to Japanese Patent Application No. 2018-137490 filed in Japan on Jul. 23, 2018, the contents of which are incorporated herein by reference.

### BACKGROUND ART

Patent Document 1 discloses a swash-plate type piston pump motor used as a hydraulic pump or a hydraulic motor. In the swash-plate type piston pump motor of the Patent Document 1, the piston shoe attached to a piston is pressed against a swash plate by a spring function of the shoe retainer.

### CITATION LIST

### Patent Literature

### Patent Document 1

### Japanese Unexamined Patent Application Publication No. 2003-113775.

### DISCLOSURE OF INVENTION

### Technical Problem

In this type of swash-plate type piston pump motor, a sliding resistance between the piston shoe and the swash plate is reduced by supplying part of the oil sucked into a cylinder in accordance with the movement of the piston between the piston shoe and the swash plate. However, in the swash-plate type piston pump motor, the force acting to move the piston shoe in a direction away from the swash plate may act on the piston shoe while deforming the shoe retainer due to the inertia force of the piston. In this case, the oil leaks out from between the piston shoe and the swash plate, and thus there is a problem in that the performance as a hydraulic pump or a hydraulic motor is reduced.

The present invention has been made in view of such problems, and an object of the present invention is to provide a swash-plate type piston pump motor capable of improving performance by suppressing oil from leaking between a piston shoe and a swash plate.

### Solution to Problem

A swash-plate type piston pump motor according to one aspect of a present invention includes: a casing; a rotary shaft rotatably mounted in the casing; a cylinder block provided in the casing and being configured to rotate together with the rotary shaft; a plurality of pistons each of which is inserted so as to be reciprocable in each of a plurality of cylinders formed in the cylinder block; a plurality of piston shoes rotatably attached to an end portion of each piston; a swash plate provided in the casing, inclined with respect to an axis of the rotary shaft, and having a sliding surface being in contact with a plurality of the piston shoes; and a shoe retainer configured to press the piston shoe against the sliding surface. Each piston shoe includes: a shoe body being in contact with the sliding surface; and an elastic body provided between the shoe body and the shoe retainer.

### Advantageous Effects of Invention

According to the swash-plate type piston pump motor of the present invention, even when the inertia force of the piston acts on the piston shoe in a direction in which the piston shoe moves away from the sliding surface of the swash plate, and even when the shoe retainer is deformed due to the inertia force of the piston, the shoe body can be pressed against the sliding surface of the swash plate by the elastic force of the elastic body. Accordingly, it is possible to suppress leakage of oil supplied between the piston shoe and the swash plate, and to improve performance of the swash-plate type piston pump motor.

### BRIEF DESCRIPTION OF DRAWINGS

FIG. 1 is a sectional view showing a swash-plate type piston pump motor according to an embodiment of the present invention.

FIG. 2 is an enlarged cross-sectional view showing part of the swash-plate type piston pump motor of FIG. 1.

FIG. 3 is a plan view showing the shoe retainer in the swash-plate type piston pump motor of FIGS. 1 and 2.

FIG. 4 is an enlarged cross-sectional view showing a piston shoe and its peripheral structure in the swash-plate type piston pump motor of FIGS. 1 and 2.

FIG. 5 is a graph showing a relationship between a hydraulic pressure and a leakage amount in the swash-plate type piston pump motor.

FIG. 6 is an enlarged cross-sectional view showing a piston shoe in a swash-plate type piston pump motor according to another embodiment of the present invention.

FIG. 7 is a cross-sectional view taken along line VII-VII of FIG. 6.

FIG. 8 is an enlarged cross-sectional view showing a piston shoe in a swash-plate type piston pump motor according to another embodiment of the present invention.

### BEST MODE FOR CARRYING OUT THE INVENTION

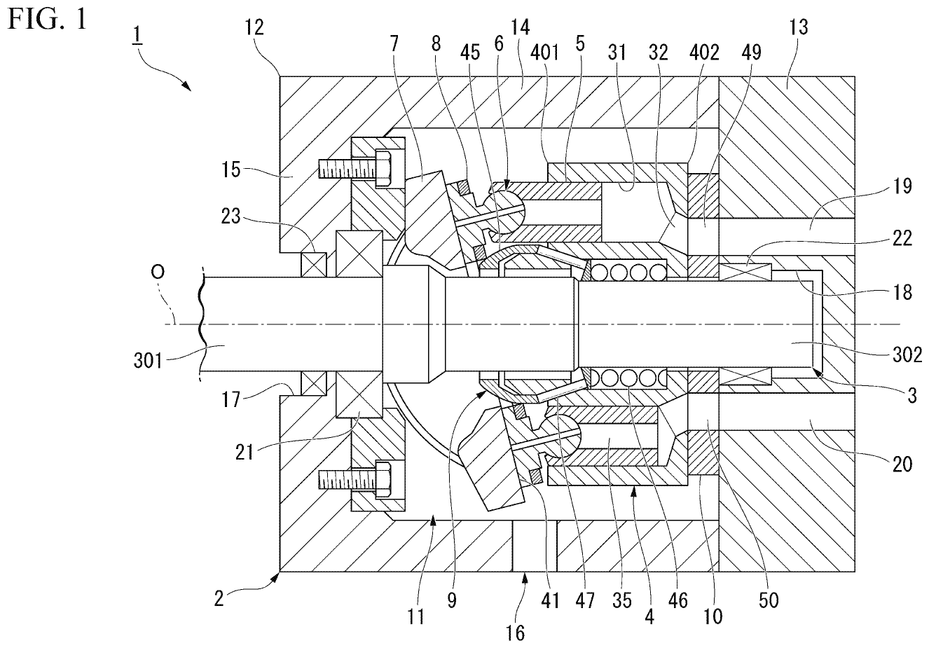

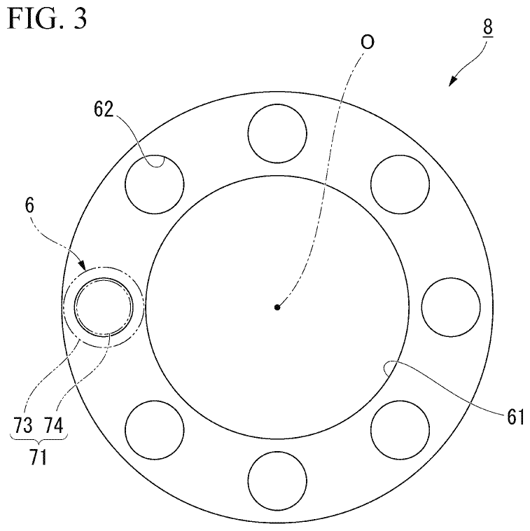

Hereinafter, an embodiment of the present invention of will be described in detail with reference to FIG. 1 to FIG. 5.

### <Swash-Plate Type Piston Pump Motor>

As shown in FIG. 1, a swash-plate type piston pump motor 1 includes a casing 2, a rotary shaft 3, a cylinder block 4, a plurality of pistons 5, a plurality of piston shoes 6, a swash plate 7, and a shoe retainer 8. Further, the swash-plate type piston pump motor 1 includes a retainer guide 9 and a valve plate 10.

### <Casing>

The casing 2 has a cavity portion 11 that accommodates the rotary shaft 3, the cylinder block 4, the swash plate 7, and the like.

A specific configuration of the casing 2 may be freely configured. The casing 2 of the present embodiment has a case main body 12 that is formed in a bottomed cylindrical shape, and a cover 13 that closes an opening of the case main body 12. The case body 12 has a cylindrical portion 14 and an end wall portion 15 that closes one opening of the cylindrical portion 14. The cylindrical portion 14 has a through-hole 16 that penetrates the cylindrical portion 14 from an inner peripheral surface to an outer peripheral surface thereof and connects the cavity portion 11 of the casing 2 to an outer space of the cylindrical portion 14. The through-hole 16 is formed in part in a peripheral direction of the cylindrical portion 14. The end wall portion 15 has a shaft insertion hole 17 through which the rotary shaft 3 is inserted. In the cover 13, a shaft insertion hole 18 for inserting the rotary shaft 3 is formed. In the cover 13, a suction flow path 19 and a discharge flow path 20 of oil are formed.

### <Rotary Shaft>

The rotary shaft 3 is a rod-shaped member centered on an axis O. The rotary shaft 3 is rotatably mounted in the casing 2. Bearings 21 and 22 that rotatably supports the rotary shaft 3 is provided between the casing 2 and the rotary shaft 3. Specifically, the first bearing 21 is provided between an inner periphery of the shaft insertion hole 17 of the case main body 12 (end wall portion 15) and an outer periphery of the first end portion 301 of the rotary shaft 3 passed through the shaft insertion hole 17. The second bearing 22 is provided between an inner periphery of the shaft insertion hole 18 of the cover 13 and an outer periphery of the second end portion 302 of the rotary shaft 3 inserted in the shaft insertion hole 18. Further, an oil seal 23 is provided between the outer periphery of the first end portion 301 of the rotary shaft 3 and the inner periphery of the shaft insertion hole 17 to prevent oil in the casing 2 from flowing out to the outside through the shaft insertion hole 17.

### <Cylinder Block>

The cylinder block 4 is provided in the casing 2, and rotates together with the rotary shaft 3. The cylinder block 4 is formed in a cylindrical shape centered on the axis O, and is fixed on an outer periphery of the rotary shaft 3 by splines (not shown) or the like.

In the cylinder block 4, a plurality of cylinders 31 are formed. Each cylinder 31 is formed so as to extend in a direction along the axis O. Each cylinder 31 is a bottomed hole that is recessed from a first end 401 of the cylinder block 4 in an axis O direction. The plurality of cylinders 31 are arranged at intervals about the axis O in the peripheral direction of the rotary shaft 3.

The cylinder block 4 has a cylinder port 32 that penetrates from a bottom of each cylinder 31 to a second end 402 of the cylinder block 4. Similar to the cylinder 31, a plurality of cylinder ports 32 are arranged at intervals about the axis O in the peripheral direction of the rotary shaft 3.

In the present embodiment, the cylinder block 4 is arranged so that the first end 401 of the cylinder block 4 faces the end wall portion 15 of the casing 2 and the second end 402 of the cylinder block 4 faces the cover 13 of the casing 2.

### <Piston>

The plurality of pistons 5 are respectively inserted so as to be reciprocable in the plurality of cylinders 31 of the cylinder block 4. Specifically, each piston 5 is inserted into each cylinder 31 from the first end 401 side of the cylinder block 4. Each piston 5 reciprocates in the axis O direction in each cylinder 31.

Each piston 5 has a first flow hole 35 penetrating in a direction in which the piston 5 moves in the cylinder 31 (i.e., in the axis O direction).

### <Swash Plate>

The swash plate 7 is provided in the casing 2. The swash plate 7 has a sliding surface 41 that is inclined with respect to the axis O of the rotary shaft 3 and is with which a plurality of piston shoes 6 are in contact. The swash plate 7 is disposed so that the sliding surface 41 faces the first end 401 of the cylinder block 4 in the axis O direction. The swash plate 7 is attached to the casing 2 so as to be able to change an inclination angle of the sliding surface 41. By changing the inclination angle of the sliding surface 41 of the swash plate 7, a stroke amount of the piston 5 in the cylinder 31 is changed and a capacity of the swash-plate type piston pump motor 1 can be changed.

### <Retainer Guide>

The retainer guide 9 is disposed on the first end 401 side of the cylinder block 4. The retainer guide 9 supports so as to be swingable a shoe retainer 8, which will be described later. The retainer guide 9 has a hemispherical surface 45 (hereinafter referred to as a spherical surface 45) that bulges on the first end 401 side of the cylinder block 4 and is centered on the axis O.

The retainer guide 9 is pressurized by a spring member 46 and a pressing pin 47 in a direction away from the first end 401 of the cylinder block 4 in the axis O direction with respect to the cylinder block 4. The spring member 46 is provided on an inner periphery of the cylinder block 4. The pressing pin 47 is located between the spring member 46 and the retainer guide 9 in the axis O direction. A plurality of pressing pins 47 are arranged at intervals in the peripheral direction about the axis O. The spring member 46 also has a role to press the cylinder block 4 against the valve plate 10, which will be described later.

### <Valve Plate>

The valve plate 10 is disposed between the second end 402 of the cylinder block 4 and the cover 13 of the casing 2 in the axis O direction. The valve plate 10 has a suction port 49 and a discharge port 50. The intake port 49 and the discharge port 50 are each formed in an arc shape centered on the axis O. The suction port 49 and the discharge port 50 are arranged in the peripheral direction. The suction port 49 connects the cylinder port 32 of the cylinder block 4 disposed at a predetermined rotational position and the suction flow path 19 of the cover 13. The discharge port 50 connects the cylinder port 32 of the cylinder block 4 disposed at another predetermined rotational position and the discharge flow path 20 of the cover 13.

The valve plate 10 may be fixed on the cover 13, for example, or may be sandwiched between the cover 13 and the cylinder block 4 by the elastic force of the spring member 46, for example.

### <Shoe Retainer>

As shown in FIGS. 1 to 3, the shoe retainer 8 is a member for pressing the piston shoe 6 against the sliding surface 41 of the swash plate 7. The shoe retainer 8 is formed in a circular-plate shape. The shoe retainer 8 has a guide insertion hole 61 and a shoe insertion hole 62 that penetrate the shoe retainer 8 in a thickness direction thereof.

The guide insertion hole 61 is formed in a circular shape centered on the axis O when viewed in the axis O direction. The rotary shaft 3 and the retainer guide 9 are inserted into the guide insertion hole 61. The spherical surface 45 of the retainer guide 9 contacts the entire peripheral edge of the guide insertion hole 61. The shoe retainer 8 is swingable with respect to the retainer guide 9 in a state in which the entire peripheral edge of the guide insertion hole 61 is in contact with the spherical surface 45 of the retainer guide 9.

The shoe insertion hole 62 is formed in a circular shape when viewed in the axis O direction. A plurality of shoe insertion holes 62 are arranged in the peripheral direction of the guide insertion hole 61. A piston shoe 6, which will be described later, is inserted into each of the shoe insertion holes 62. A peripheral edge portion of each shoe insertion hole 62 is provided as a portion for pressing the piston shoe 6 against the swash plate 7.

The force for pressing the piston shoe 6 against the swash plate 7 by the shoe retainer 8 is the elastic force of the spring member 46 transmitted to the shoe retainer 8 via the pressing pin 47 and the retainer guide 9.

### <Piston Shoe>

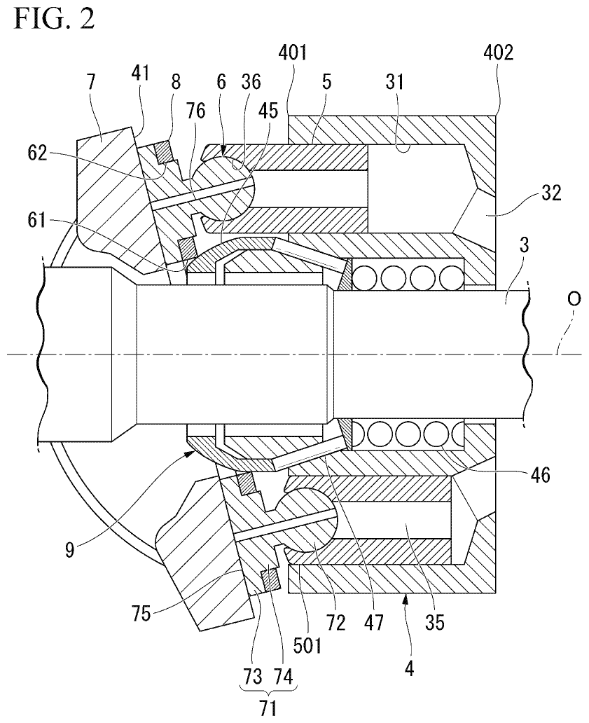

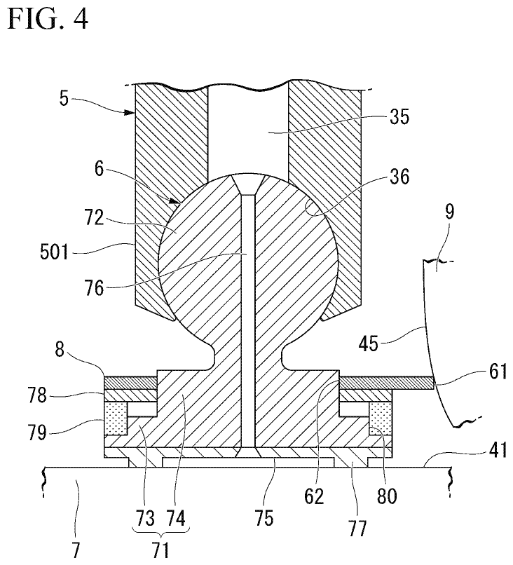

As shown in FIGS. 2 and 4, the piston shoe 6 is attached so as to be swingable to a first end portion 501 (end portion) of each piston 5. The first end portion 501 of the piston 5 is an end portion of the piston 5 located on the first end 401 side of the cylinder block 4. The piston shoe 6 includes a shoe body 71 and a spherical portion 72.

The shoe body 71 is a portion of the piston shoe 6 that is in contact with the sliding surface 41 of the swash plate 7, and is a portion that is pressed against the sliding surface 41 by the shoe retainer 8. The shoe body 71 includes a large-diameter portion 73 and a small-diameter portion 74. The large-diameter portion 73 is a portion including a facing surface 75 of the shoe body 71 that faces the sliding surface 41 of the swash plate 7. The small-diameter portion 74 is located between the large-diameter portion 73 and the spherical portion 72. A diameter size of the small-diameter portion 74 is smaller than a diameter size of the large-diameter portion 73.

As shown in FIGS. 2 to 4, the small-diameter portion 74 is inserted into the shoe insertion hole 62 of the shoe retainer 8. For this reason, the diameter size of the small-diameter portion 74 only needs to be at least smaller than the inner diameter size of the shoe insertion hole 62. However, it is preferable that the difference between the diameter size of the small-diameter portion 74 and the inner diameter size of the shoe insertion hole 62 is small so as to prevent the shoe body 71 (the piston shoe 6) from being displaced relative to the shoe retainer 8.

The large-diameter portion 73 is disposed so as to overlap the peripheral edge portion of the shoe insertion hole 62 in a state in which the small-diameter portion 74 is inserted into the shoe insertion hole 62. That is, the large-diameter portion 73 of the shoe body 71 is provided as a portion of the shoe body 71 that is pressed against the sliding surface 41 of the swash plate 7 by the shoe retainer 8.

As shown in FIGS. 2 and 4, the spherical portion 72 is integrally formed with the shoe body 71. The spherical portion 72 is rotatably accommodated in an accommodating recess 36 formed in the first end portion 501 of the piston 5. As a result, the piston shoe 6 is swingable with respect to each piston 5.

The shoe body 71 and the spherical portion 72 has a second flow hole 76. The second flow hole 76 penetrates from a surface region of the spherical portion 72 exposed to the first flow hole 35 of the piston 5 to the facing surface 75 of the shoe body 71. As a result, part of the oil in the cylinder 31 is supplied between the sliding surface 41 of the swash plate 7 and the facing surface 75 of the shoe body 71 via the first flow hole 35 of the piston 5 and the second flow hole 76 of the piston shoe 6.

As shown in FIG. 4, the facing surface 75 of the shoe body 71 has an annular projection 77 surrounding a region of the facing surface 75 into which the second flow hole 76 is open. By the annular projection 77 being pressed against the sliding surface 41 of the swash plate 7, the oil supplied to a gap between the sliding surface 41 of the swash plate 7 and the facing surface 75 of the shoe body 71 can be held in the gap.

The piston shoe 6 further includes a retainer receiving member 78 and an elastic body 79. The retainer receiving member 78 is disposed between the shoe body 71 and the shoe retainer 8. The retainer receiving member 78 is provided so as to be movable in an arrangement direction of the shoe body 71 and the shoe retainer 8 with respect to the shoe body 71. Specifically, the retainer receiving member 78 is formed in an annular plate shape. The small-diameter portion 74 of the shoe body 71 is inserted through the retainer receiving member 78. Accordingly, the retainer receiving member 78 is located between the large-diameter portion 73 of the shoe body 71 and the shoe retainer 8 and is movable between the large-diameter portion 73 of the shoe body 71 and the shoe retainer 8. In the present embodiment, the inner diameter size of the retainer receiving member 78 is the same as the inner diameter size of the shoe insertion hole 62 of the shoe retainer 8. Further, an outer diameter size of the retainer receiving member 78 is the same as the diameter size of the large-diameter portion 73 of the shoe body 71.

The elastic body 79 is an elastically deformable member that is provided between the shoe body 71 and the retainer receiving member 78. The elastic body 79 may be, for example, a spring coil, a wave washer, a leaf spring, or the like, but is made of rubber (for example, fluororubber) in the present embodiment.

In the present embodiment, the elastic body 79 is provided in a state of being elastically compressed between the large-diameter portion 73 of the shoe body 71 and the retainer receiving member 78. Specifically, the elastic body 79 is elastically compressed in a state in which the piston shoe 6 is pressed against the sliding surface 41 of the swash plate 7 by the shoe retainer 8. In this state, the shoe body 71 is pressed against the sliding surface 41 of the swash plate 7 by the elastic force of the elastic body 79.

The elastic body 79 of the present embodiment is formed in an annular shape. Similarly to the retainer receiving member 78, the small-diameter portion 74 of the shoe body 71 is inserted into the elastic body 79. The inner diameter size of the elastic body 79 may be, for example, the same as the inner diameter size of the retainer receiving member 78, but is larger than the inner diameter size of the retainer receiving member 78 in the present embodiment. For this reason, when the elastic body 79 is elastically compressed by the retainer receiving member 78 being brought close to the shoe body 71, the elastic body 79 can be displaced so as to bulge radially inward or radially outward. Further, part of the elastic body 79 enters a notch 80 formed in the outer peripheral edge of the large-diameter portion 73. As a result, it possible to prevent the positional displacement of the elastic body 79 relative to the shoe body 71. The outer diameter size of the elastic body 79 may be different from the outer diameter size of the retainer receiving member 78, but in the present embodiment, the outer diameter size is equal to the outer diameter of the retainer receiving member 78.

The swash-plate type piston pump motor 1 of the present embodiment may be a hydraulic pump that supplies oil based on a rotational driving force of a motor or the like, or may be a hydraulic motor that drives the rotary shaft 3 by a hydraulic pressure. Hereinafter, an operation in a case where the swash-plate type piston pump motor 1 is a hydraulic pump will be described.

### <Operation and Effects>

In the swash-plate type piston pump motor 1 of the present embodiment, each piston shoe 6 attached to each piston 5 is pressed against the sliding surface 41 of the swash plate 7 by the shoe retainer 8. Therefore, when the rotary shaft 3 rotates by a motor or the like, the pistons 5 reciprocate in the respective cylinders 31 in accordance with the rotation of the cylinder block 4.

Specifically, when the piston shoe 6 moves to a far region from a close region of the sliding surface 41 of the swash plate 7 with respect to the first end 401 of the cylinder block 4 along with the rotation of the rotary shaft 3, the piston 5 corresponding to the piston shoe 6 moves in the direction (leftward direction in the FIG. 2) approaching the swash plate 7. As a result, the oil is sucked into the corresponding cylinder 31 through the suction flow path 19 of the casing 2 and the suction port 49 of the valve plate 10. Part of the oil sucked into the cylinder 31 is supplied between the sliding surface 41 of the swash plate 7 and the facing surface 75 of the shoe body 71 via the first flow hole 35 of the piston 5 and the second flow hole 76 of the piston shoe 6.

On the other hand, when the piston shoe 6 moves from a far region to a close region of the sliding surface 41 of the swash plate 7 with respect to the first end 401 of the cylinder block 4, the piston 5 corresponding to the piston shoe 6 moves in a direction away from the swash plate 7 and oil is discharged from an inside of the corresponding cylinder 31. The oil in the cylinder 31 is discharged to an outside through the discharge port 50 of the valve plate 10 and the discharge flow path 20 of the casing 2.

By continuously sucking and discharging the oil in this way, the oil is supplied.

In the state where the swash-plate type piston pump motor 1 is operating as described above, the pressing force for pressing the piston shoe 6 against the sliding surface 41 of the swash plate 7 also includes a pressure of the oil (hydraulic pressure) in the cylinder 31 in addition to the elastic force of the shoe retainer 8 (spring member 46) and the elastic force of the elastic body 79.

In a step of discharging the oil from the inside of the cylinder 31 (discharge step), the hydraulic pressure in the cylinder 31 is large. For this reason, the pressing force for pressing the piston shoe 6 against the sliding surface 41 of the swash plate 7 is large. However, in the discharge step, since the pressure of the oil (hydraulic pressure) supplied between the swash plate 7 and the piston shoe 6 is large, the sliding resistance between the piston shoe 6 and the swash plate 7 does not increase.

On the other hand, in a step of sucking the oil into the cylinder 31 (suction step), the hydraulic pressure in the cylinder 31 is small. For this reason, the pressing force for pressing the piston shoe 6 against the sliding surface 41 of the swash plate 7 is smaller than that for the discharge step.

Further, when the oil is supplied as described above, the oil in the cylinder 31 leaks out from between the cylinder 31 and the piston 5, or the oil supplied between the swash plate 7 and the piston shoe 6 leaks out. The leaked oil is discharged to the outside of the casing 2 through the through-hole 16 of the casing 2. The discharged oil may be supplied again into the cylinder 31.

In the operation of the swash-plate type piston pump motor 1 described above, when switching from the discharge step to the suction step, force in a direction away from the sliding surface 41 of the swash plate 7 acts on the piston shoe 6 due to inertia force of the piston 5. Further, due to the inertia force of the piston 5, a portion of the shoe retainer 8 that presses the piston shoe 6 (shoe body 71) against the swash plate 7 may deform so as to bend with respect to the other portion of the shoe retainer 8. Therefore, when the piston shoe 6 is not provided with the elastic body 79, the pressing force of the shoe retainer 8 to the swash plate 7 of the piston shoe 6 decreases, and a leakage of the oil supplied between the swash plate 7 and the piston shoe 6 may increase.

On the other hand, in the swash-plate type piston pump motor 1 of the present embodiment, the elastic body 79 is provided between the shoe retainer 8 and the shoe body 71. Therefore, even when the inertial force of the piston 5 in the direction in which the piston shoe 6 is separated from the swash plate 7 acts on the piston shoe 6 or the shoe retainer 8 is deformed, the shoe body 71 can be pressed against the sliding surface 41 of the swash plate 7 by the elastic force of the elastic body 79. In particular, in the present embodiment, the elastic body 79 is provided in a state of being elastically compressed between the large-diameter portion 73 of the shoe body 71 and the retainer receiving member 78. Therefore, even when the shoe retainer 8 is deformed, the shoe body 71 can be reliably pressed against the sliding surface 41 of the swash plate 7 by the elastic force of the elastic body 79. Accordingly, it is possible to prevent the oil supplied between the sliding surface 41 of the swash plate 7 and the facing surface 75 of the shoe body 71 from leaking out.

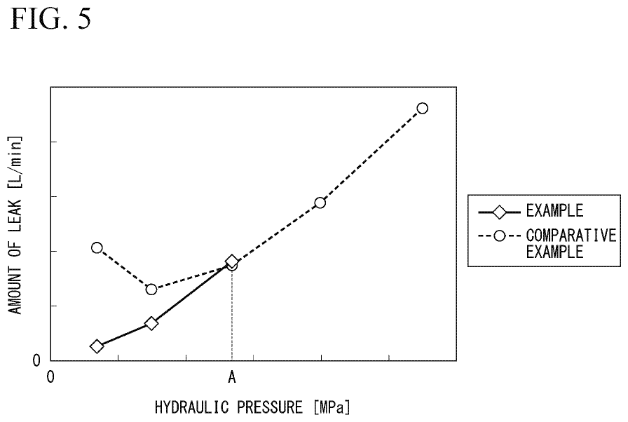

The reason of suppressing leakage of oil in the swash-plate type piston pump motor 1 of the present embodiment will be described with reference to FIG. 5.

The graph shown in FIG. 5 indicates a relationship between a discharge pressure of oil (hydraulic pressure) in a swash-plate type piston pump motor as a hydraulic pump and a leakage amount of oil (amount of leak) of a swash-plate type piston pump motor. The discharge pressure of the oil is the pressure of the oil discharged from the cylinder 31. The discharge pressure of the oil can be changed, for example, by changing the rotation speed of the rotary shaft 3. For example, it is possible to increase the discharge pressure of the oil by increasing the rotation speed of the rotary shaft 3. The leakage amount of oil is the amount of oil discharged from the through-hole 16 of the casing 2.

In the graph of FIG. 5, “Example” is an experimental result of the swash-plate type piston pump motor 1 of the present embodiment in which the piston shoe 6 includes the retainer receiving member 78 and the elastic body 79. On the other hand, “Comparative Example” is an experimental result of a swash-plate type piston pump motor in which the piston shoe 6 does not include the retainer receiving member 78 and the elastic body 79.

In “Comparative Example”, when the discharge pressure of the oil is relatively high (when the discharge pressure of the oil is equal to or higher than the predetermined value A in FIG. 5), the leakage amount of oil tends to increase as the discharge pressure of the oil increases. Even when there is no change in the gap between the piston 5 and the cylinder 31 and in the gap between the piston shoe 6 and the swash plate 7, the leakage amount of oil increases when the oil pressure in the cylinder 31 increases, and thus there is no problem in the tendency of this point.

However, in “Comparative Example”, when the discharge pressure of the oil is relatively low (when the discharge pressure of the oil is equal to or less than the predetermined value A in FIG. 5), the leakage amount of oil tends to increase as the discharge pressure of the oil decreases. This tendency shows that it is caused by an increase in the gap between the swash plate 7 and the piston shoe 6 due to the inertia force of the piston 5 described above.

On the other hand, in “Example”, when the discharge pressure of the oil is relatively low (when the discharge pressure of the oil is equal to or less than the predetermined value A in FIG. 5), the leakage amount of oil tends to decrease as the discharge pressure of the oil decreases. As described above, this tendency shows that the shoe body 71 is pressed against the sliding surface 41 of the swash plate 7 by the elastic force of the elastic body 79, so that an increase in the gap between the swash plate 7 and the piston shoe 6 due to the inertia force of the piston 5 is suppressed or prevented. As a result, the leakage of the oil can be suppressed.

In addition, the experimental result of “Example” does not include the result when the discharge pressure of the oil is relatively high, but it is inferred that the result is the same as the experiment result of “Comparative Example”. Therefore, in the swash-plate type piston pump motor 1 of the present embodiment, the relationship between the discharge pressure of the oil and the leakage amount of oil can be a direct proportional relationship.

Further, according to the swash-plate type piston pump motor 1 of the present embodiment, since the shoe body 71 is pressed against the swash plate 7 by the elastic force of the elastic body 79, it is possible to form the shoe retainer 8 in a simple plate shape having no spring function. As a result, when the shoe retainer 8 rotates in the oil leaked into the casing 2, the resistance (stirring resistance) generated between the shoe retainer 8 and the oil can be suppressed to a small value. In addition, the shoe retainer 8 can be easily manufactured. If the shoe retainer 8 is provided with a spring function as in Patent Document 1, the shoe retainer 8 has a complicated shape. Therefore, the above-described stirring resistance becomes large. Further, in order to have a spring function to the shoe retainer 8, it is necessary to perform bending processing or the like on the shoe retainer 8, and manufacturing of the shoe retainer 8 becomes troublesome.

Furthermore, according to the swash-plate type piston pump motor 1 of the present embodiment, the shoe retainer 8 can be formed in a simple plate shape without a spring function, so that the shoe retainer 8 only needs to be formed so as to ensure rigidity only. Therefore, it is possible to easily reduce the size of the shoe retainer 8. That is, the volume occupied by the shoe retainer 8 in the cavity portion 11 of the casing 2 can be reduced. Therefore, it is possible to reduce the size of the swash-plate type piston pump motor 1. If the shoe retainer 8 has a spring function as in Patent Document 1, it is necessary to ensure both the spring function and the rigidity of the shoe retainer 8, and thus the shoe retainer 8 is increased in size. That is, the volume occupied by the shoe retainer 8 in the cavity portion 11 of the casing 2 increases. As a result, it becomes difficult to downsize the swash-plate type piston pump motor 1.

In addition, the swash-plate type piston pump motor 1 of the present embodiment is configured so that the shoe body 71 is pressed against the swash plate 7 by the elastic body 79 disposed between the shoe body 71 and the retainer receiving member 78. Therefore, even when the shoe retainer 8 is deformed due to the inertia force of the piston 5, it is possible to suppress or prevent unintentionally changing of pressing force of the shoe body 71 due to the elastic body 79. That is, the shoe body 71 can be pressed against the swash plate 7 by the stable elastic force of the elastic body 79.

If the shoe retainer 8 has a spring function for pressing the piston shoe 6 against the swash plate 7 as in Patent Document 1, when the shoe retainer 8 deforms due to the inertia force of the piston 5, the spring function of the shoe retainer 8 irregularly changes. Therefore, the pressing force of the piston shoe 6 by the shoe retainer 8 is unintentionally changed, and the piston shoe 6 cannot be stably pressed against the swash plate 7.

Further, according to the swash-plate type piston pump motor 1 of the present embodiment, the elastic body 79 is provided between the shoe body 71 and the shoe retainer 8. Therefore, even when the shoe retainer 8 deforms due to the inertia force of the piston 5, the entire portion of the shoe body 71 facing the sliding surface 41 of the swash plate 7 (specifically, the entire annular projection 77) can be uniformly brought into contact with the sliding surface 41 of the swash plate 7 due to the elastic force of the elastic body 79. Accordingly, the sliding resistance generated between the shoe body 71 and the swash plate 7 can be reduced, and the occurrence of uneven wear in the portion of the shoe body 71 that comes into contact with the sliding surface 41 of the swash plate 7 can be suppressed or prevented. Therefore, it is possible to use the same piston shoe 6 for a long period of time. If the shoe retainer 8 has a spring function as in Patent Document 1, when the shoe retainer 8 deforms due to the inertia force of the piston 5, the contact between the shoe retainer 8 and the piston shoe 6 becomes uneven, and only part of the portion of the piston shoe 6 facing the sliding surface 41 of the swash plate 7 comes into contact with the sliding surface 41 of the swash plate 7. In this case, the sliding resistance generated between the piston shoe 6 and the swash plate 7 increases, and uneven wear occurs in the piston shoe 6. As a result, it becomes difficult to use the same piston shoe 6 for a long period of time.

In addition, according to the swash-plate type piston pump motor 1 of the present embodiment, the retainer receiving member 78 is provided between the elastic body 79 and the shoe retainer 8. Accordingly, as compared with a case where the elastic body 79 and the shoe retainer 8 are in direct contact with each other, deterioration of the elastic body 79 and the shoe retainer 8 due to wear can be suppressed or prevented. Therefore, it is possible to improve the durability of the swash-plate type piston pump motor 1.

### Other Embodiment

The embodiment of the present invention has been described above, but the present invention is not limited thereto, and may be appropriately modified without departing from the technical idea of the invention.

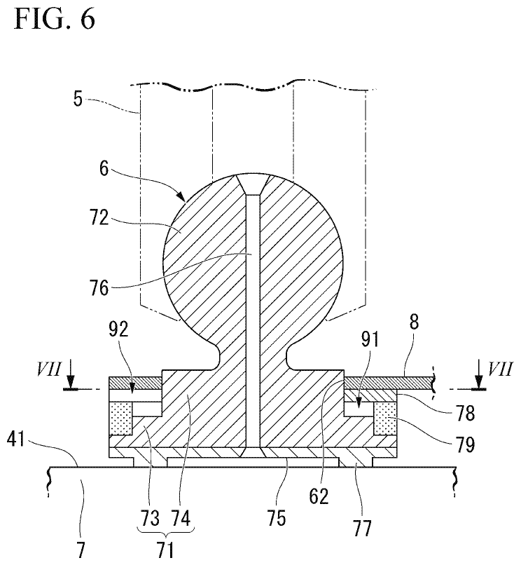

In the swash-plate type piston pump motor of the present invention, as shown in, for example, FIGS. 6 to 8, a notch 92 or a hole 93 that connects a gap space 91 between the shoe body 71 and the retainer receiving member 78 to the outside may be formed in the retainer receiving member 78. In FIGS. 6 to 8, the gap space 91 between the shoe body 71 and the retainer receiving member 78 is an annular space formed between the large-diameter portion 73 of the shoe body 71 and the retainer receiving member 78. An inner periphery of the gap space 91 is closed by the small-diameter portion 74 of the shoe body 71. Further, an outer periphery of the gap space 91 is closed by the elastic body 79.

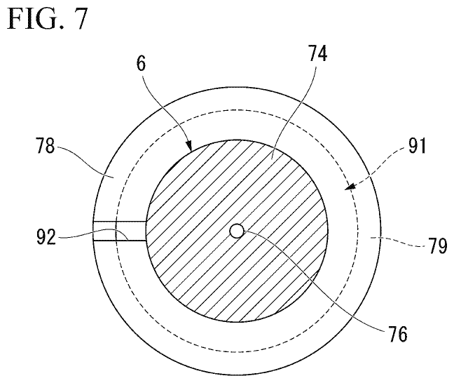

The notch 92 connecting the gap space 91 to the outside may be formed in part in a peripheral direction of the retainer receiving member 78 formed in an annular shape as shown in the FIGS. 6 and 7. The notch 92 may be formed so as to extend from at least the outer periphery of the retainer receiving member 78 to a radially inside of the retainer receiving member 78. In the shown example, the notch 92 penetrates from the outer periphery of the retainer receiving member 78 to the inner periphery thereof.

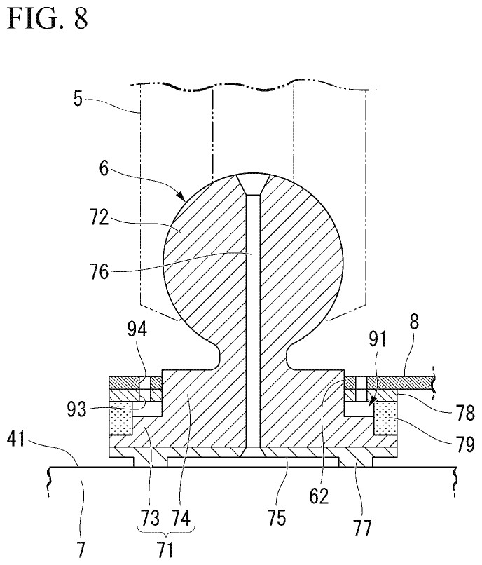

The hole 93 connecting the gap space 91 to the outside may be formed to penetrate in the plate thickness direction of the retainer receiving member 78, as shown in the FIG. 8. In this case, since the hole 93 of the retainer receiving member 78 is covered by the shoe retainer 8, a hole 94 connecting the hole 93 of the retainer receiving member 78 to the outside may be formed in the shoe retainer 8. The holes 93, 94 formed in the retainer receiving member 78 and the shoe retainer 8 may be, for example, one, or may be arranged at intervals in the circumferential direction of the retainer receiving member 78 as shown in the FIG. 8.

In a case where the gap space 91 is sealed against the outside, when the retainer receiving member 78 and the shoe body 71 (particularly, the large-diameter portion 73) are caused to relatively move in the arrangement direction thereof, an air pressure in the gap space 91 changes and thus there is a possibility that the relative movement between the retainer receiving member 78 and the shoe body 71 is hindered. For example, when the shoe body 71 is caused to move in a direction away from the sliding surface 41 of the swash plate 7 due to the inertia force of the piston 5, the air pressure in the gap space 91 increases. Therefore, the retainer receiving member 78 moves in a direction away from the sliding surface 41 of the swash plate 7 by following the movement of the shoe body 71. As a result, there is a possibility that the elastic force of the elastic body 79 which presses the shoe body 71 against the sliding surface 41 of the swash plate 7 becomes insufficient.

In contrast, according to the configuration exemplified in FIGS. 6 to 8, the air enters and exits the gap space 91, thereby a relative movement between the retainer receiving member 78 and the shoe body 71 (in particular, the large-diameter portion 73) is allowed. For example, when the shoe body 71 is caused to move in a direction away from the sliding surface 41 of the swash plate 7 due to the inertia force of the piston 5, the air in the gap space 91 is discharged to the outside through the notch 92 and the hole 93 of the retainer receiving member 78, and an increase in air pressure in the gap space 91 can be suppressed or prevented. Accordingly, it is possible to suppress or prevent the retainer receiving member 78 from following the movement of the shoe body 71. As a result, it is possible to sufficiently obtain the elastic force of the elastic body 79 pressed against the sliding surface 41 of the swash plate 7.

In the swash-plate type piston pump motor of the present invention, the piston shoe 6 does not have to include, for example, the retainer receiving member 78. That is, the shoe retainer 8 may be directly in contact with the elastic body 79.

In the swash-plate type piston pump motor of the present invention, the piston shoe may be attached to at least the first end portion of the piston so as to be swingable. For example, a spherical portion may be formed in the first end portion of the piston, and the piston shoe may include an accommodating recess for accommodating the spherical portion of the piston so as to be rotatable.

### INDUSTRIAL APPLICABILITY

According to the swash-plate type piston pump motor of the present invention, even when the inertia force of the piston acts on the piston shoe in a direction in which the piston shoe moves away from the sliding surface of the swash plate, and even when the shoe retainer is deformed due to the inertia force of the piston, the shoe body can be pressed against the sliding surface of the swash plate by the elastic force of the elastic body. Accordingly, it is possible to suppress leakage of oil supplied between the piston shoe and the swash plate and to improve performance of the swash-plate type piston pump motor.

### REFERENCE SIGNS LIST

1: Swash-plate type piston pump motor
2: Casing
3: Rotary shaft
4: Cylinder block
5: Piston
6: Piston shoe
7: Swash plate
8: Shoe retainer
9: Retainer guide
10: Valve plate
31: Cylinder
35: First flow hole
41: Sliding surface of Swash plate 7
71: Shoe Body
72: Spherical portion
73: Large-diameter portion
74: Small-diameter portion
75: Facing surface
76: Second flow hole
77: Annular projection
78: Retainer receiving member
79: Elastic Body
91: Gap space
92: Notch
93: Hole
501: First end portion (end portion) of Piston 5
O: Axis

1. A swash-plate type piston pump motor comprising:
a casing;
a rotary shaft rotatably mounted in the casing;
a cylinder block provided in the casing and being configured to rotate together with the rotary shaft;
a plurality of pistons each of which is inserted so as to be reciprocable in each of a plurality of cylinders formed in the cylinder block;
a plurality of piston shoes attached so as to be swingable to an end portion of each piston;
a swash plate provided in the casing, inclined with respect to an axis of the rotary shaft, and having a sliding surface being in contact with a plurality of the piston shoes; and
a shoe retainer configured to press the piston shoe against the sliding surface,
wherein each piston shoe includes:
a shoe body being in contact with the sliding surface; and
an elastic body provided between the shoe body and the shoe retainer.

2. The swash-plate type piston pump motor according to claim 1,
wherein each of the piston shoes is provided with a retainer receiving member disposed between the elastic body and the shoe retainer.

3. The swash-plate type piston pump motor according to claim 2,
wherein the retainer receiving member has a notch or a hole that connects a gap space between the shoe body and the retainer receiving member to an outside.

4. The swash-plate type piston pump motor according to claim 1,
wherein the elastic body is provided between the shoe body and the shoe retainer in a state in which the elastic body is elastically compressed.
